(19) United States
(12) Patent Application Publication
(10) Pub. No.: US 2008/0201920 A1
(43) Pub. Date: Aug. 28, 2008

(54) Fastening divice

(75) Inventor: Stefan Jatzke, Ebertsheim (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH

(21) Appl. No.: 12/070,612

(22) Filed: Feb. 20, 2008

(30) Foreign Application Priority Data
Feb. 22, 2007 (DE) 20 2007 002 595.5

(51) Int. Cl. B42F 1/00

(52) U.S. Cl. 24/458

(57) ABSTRACT

A fastening device comprises a fastening clip (12) and a module support part (14) having an opening (16) to receive the fastening clip (12), wherein the fastening clip (12) has a shaft (18) and a head part (20) which is formed onto the shaft. Locking elements (22) are provided on the shaft (18) underneath the head part (20), which locking elements engage into the opening (16) of the module support part (14) and secure the fastening clip (12) on the module support part. The fastening device is used for fastening a module support and a panelling piece on a raw component such as a door plate of a motor vehicle.

### FIELD OF THE INVENTION

The invention relates to a fastening device, in particular for fastening a module support and a panelling piece on a raw component such as a door plate of a motor vehicle.

### BACKGROUND OF THE INVENTION

Module supports usually serve for the fastening of mechanical and/or electrical operating- and control modules which are integrated in a vehicle door, such as window levers for example. The module supports which are currently used are aluminium parts which are fastened to the raw component of the vehicle door with metal blind rivets. Through this type of fastening, an undulation of the module support can occur, from which a lack of tightness can result.

The fastening of the inner door lining on the raw component of the vehicle door usually takes place by fastening elements which are mounted on the lining or panelling piece and which are detachably connected with the raw component.

### SUMMARY OF THE INVENTION

It is an object of the present invention to provide a fastening device by which both the module support and also the panelling piece are jointly fastened in a detachable manner on the raw component of the vehicle, such as a door plate, and by which, through simplifying the working steps during the fastening of the module support and the inner panelling of the door, the installation time and therefore also the installation costs can be reduced.

According to the invention, the fastening device comprises a fastening clip and a module support part having an opening to receive the fastening clip, wherein the fastening clip has a shaft and a head part which is formed onto the shaft. Locking elements are provided on the shaft underneath the head part, which locking elements engage into the opening of the module support part and secure the fastening clip on the module support part.

In a preferred embodiment, the invention provides a multi-part fastening device having detent elements in the lower part of the fastening clip for fastening to the body of the vehicle, in particular for mounting in a bore of the raw component of the vehicle body, and having a mounting bore in the head part of the fastening clip comprising further detent elements for engaging with a pin-shaped fastening element which holds the door panelling. The module support part can be formed from plastic. The fastening device according to the invention makes multiple, non-destructive dismantling possible. In addition, by simplifying the working steps during the fastening of the module support and the door panelling, the installation time and therefore the installation costs are reduced.

Preferable embodiments of the invention are indicated in the sub-claims. In particular, the locking elements on the fastening clip can be formed by one or more projections protruding radially from the shaft. Thereby, it is possible to quickly and safely secure the fastening clip to the module support part in the form of a bayonet lock.

The head part of the fastening clip preferably has a disc-shaped element with a circumferential seal for sealing the opening in the head part. In addition, the head part can have a mounting for a fastening element of the panelling part and a drive section comprising an outer edge, respectively.

The opening in the module support part preferably corresponds to the shape of the locking elements on the shaft of the fastening clip. Further, the module support part may have a stop for the locking elements. The module support part also preferably has a flange for tight abutment against the raw component of the vehicle body.

The fastening clip and the module support part preferably form a pre-assembled unit so that the mounting of the assembly into the vehicle is significantly facilitated.

Moreover, the fastening element of the panelling part preferably has a pin-shaped section which engages into the mounting of the head part. The shaft of the fastening clip may include a cavity corresponding to the mounting in the head part and the pin-shaped section of the fastening element engages into the cavity. Further, the pin-shaped section preferably has a detent ring by which the pin-shaped section is secured in the mounting in the head part.

The pin-shaped section may have a seal for sealing the pin-shaped section to the opening in the module support. The detent ring preferably has a sealing lip which seals the pin-shaped section against the mounting in the head part.

The fastening clip and the module support part are preferably formed from plastic. This contributes to simple and inexpensive manufacturing by injection molding. Finally, the fastening element for the panelling part can also have a head part comprising tolerance equalizing means.

### BRIEF DESCRIPTION OF THE DRAWINGS

FIG. 1 shows the fastening clip of the fastening device according to the invention, and the pin-shaped fastening element for the door lining;

FIG. 2a shows the introduction of the fastening clip into the opening of the module support;

FIG. 2b shows a view from the underside of the module support with the fastening clip introduced;

FIG. 3 shows the locking of the fastening clip on the module support by rotating the fastening clip in the opening via an octagon through 90° clockwise up to a stop;

FIG. 4 shows the installation of the module support with the fastening clip in an opening in the door plate by means of detent elements;

FIG. 5 shows a diagrammatic view of the pre-assembled module support in the door plate;

FIG. 6 shows the installation of the door panelling (not illustrated) with pre-assembled pin-type fastening element into the module support;

FIG. 7 shows the centering of the pin-shaped fastening element in the module support via the mounting in the head part of the fastening clip with a chamfer;

FIG. 8 shows the seat of the pin-shaped fastening element for the door panelling in the module support and door plate in a diagrammatic illustration;

FIG. 9 shows sectional view for a functional description of individual components of the fastening device according to the invention.

### DETAILED DESCRIPTION OF PREFERRED EMBODIMENT(S)

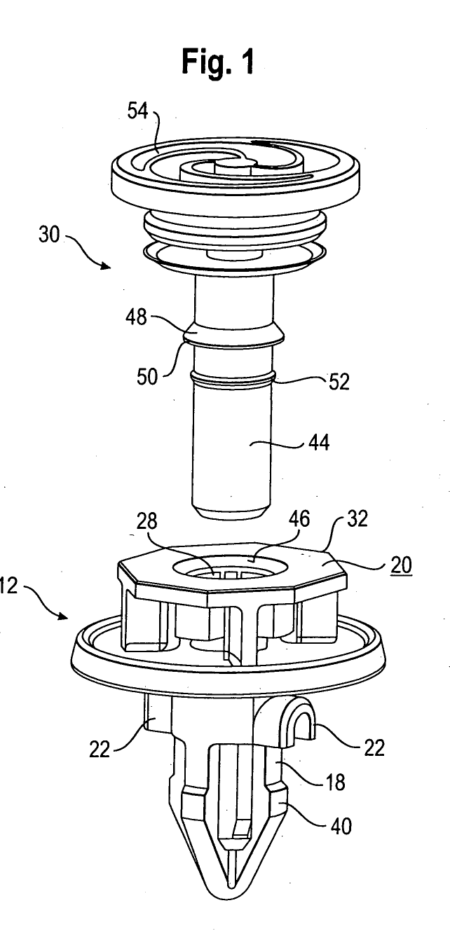

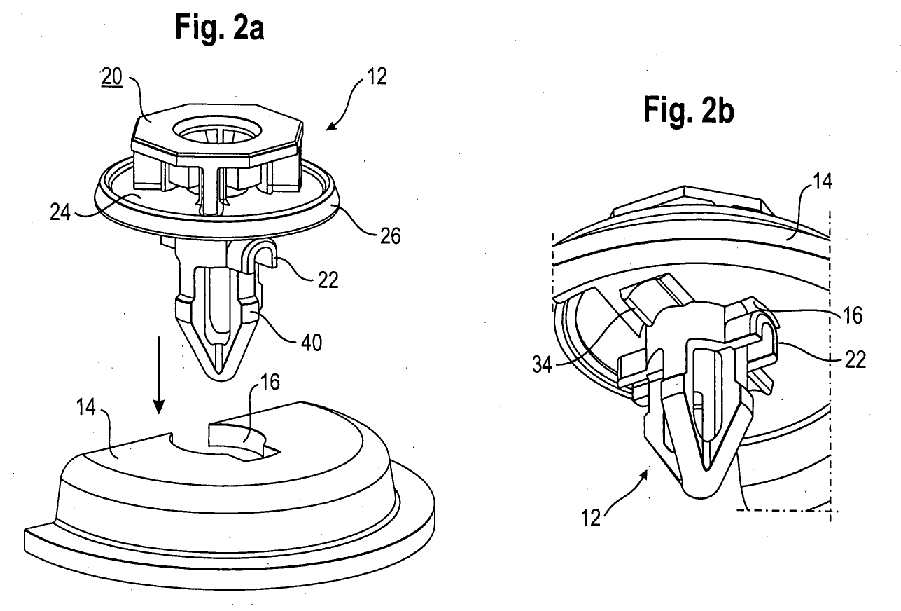

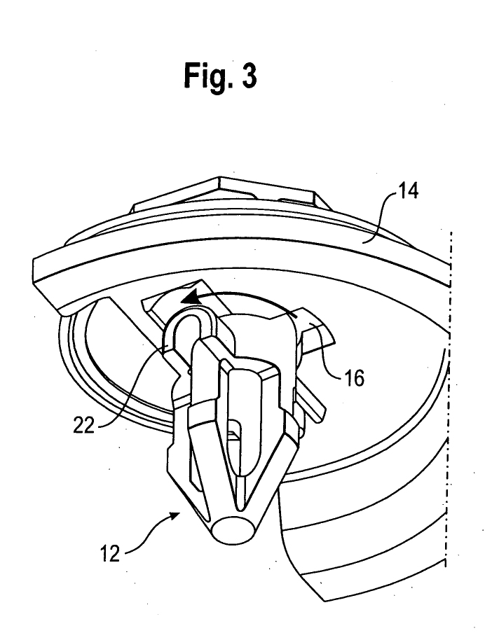

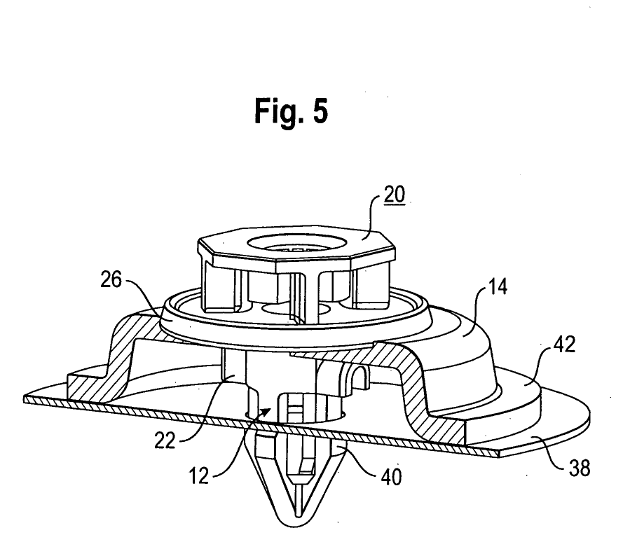

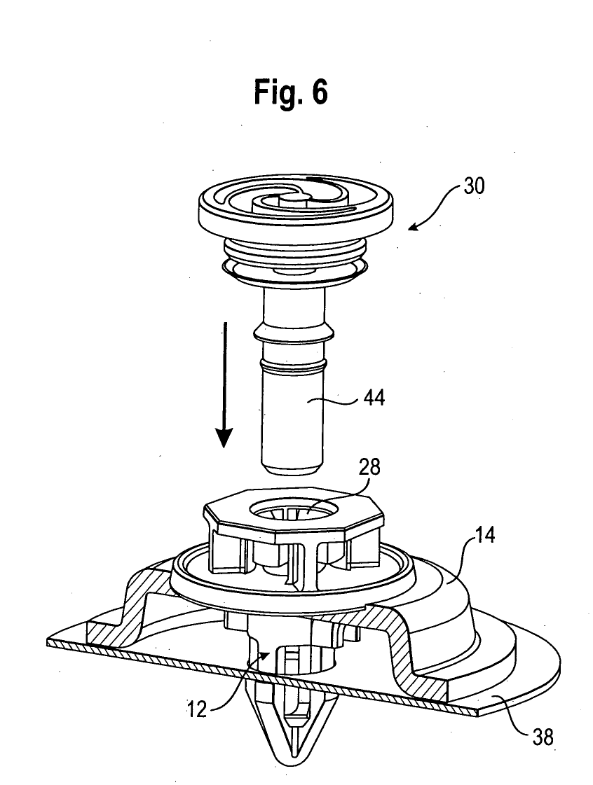

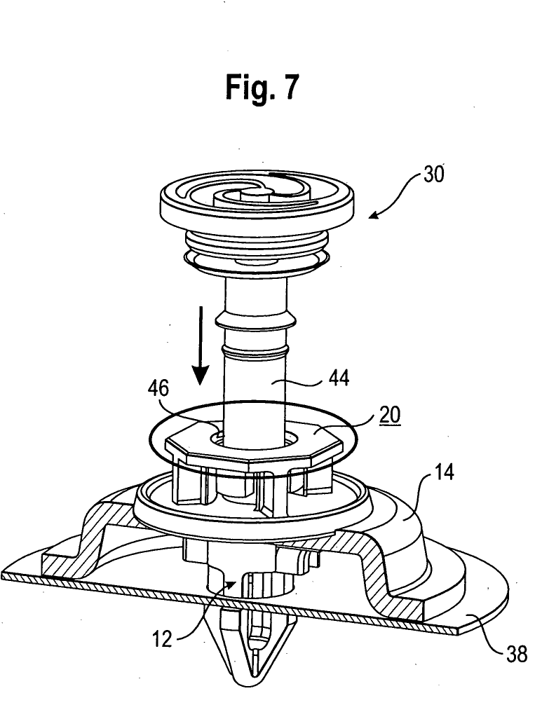

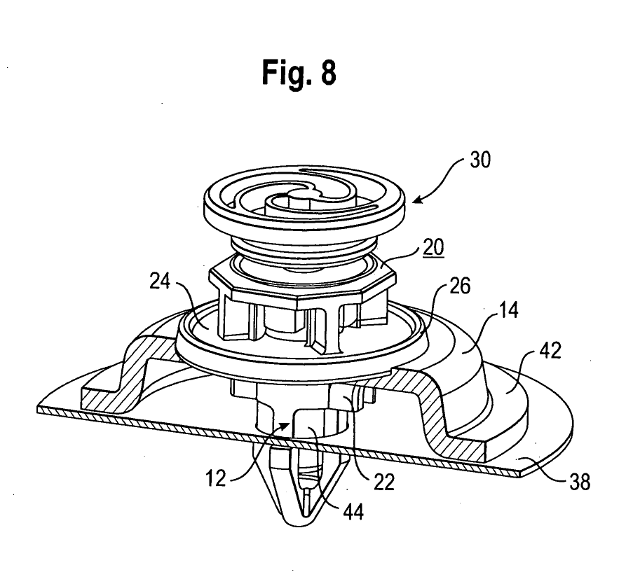

A preferred embodiment of the fastening device according to the invention is shown in the enclosed drawings, FIGS. 1 to 9. The fastening device according to the invention comprises a fastening clip 12 and a module support part 14. An opening 16 to receive the fastening clip 12 is provided in the module support part 14. The fastening clip 12 has a shaft 18 and a head part 20 which is formed onto the shaft. Beneath the head part 20, locking elements 22 are provided on the shaft 18, which engage into the opening 16 of the module support part 14 and secure the fastening clip 12 on the module support part 14 (FIGS. 1 to 3).

The locking elements 22 are preferably formed by one or more projections protruding radially from the shaft 18. The head part 20 of the fastening clip 12 may additionally have a disc-shaped element 24 with a circumferential seal 26. In the assembled state, the opening 16 of the module support 14 is sealed with the disc-shaped element and the encircling seal 26.

In the head part 20, a mounting 28 is formed for a fastening element, designated by reference number 30, of a panelling part (not illustrated). Furthermore, the head part has a drive section 32 with an outer edge which is formed as an octagon in the embodiment shown. The fastening clip 12 which is introduced into the module support part 14 can be rotated via the drive section and can be locked on the module support part 14. A stop 34 is preferably formed on the underside of the module support part 14, which stop 34 delimits the rotation of the locking elements 22 and defines the position of the fastening clip 12 in the module support part 14.

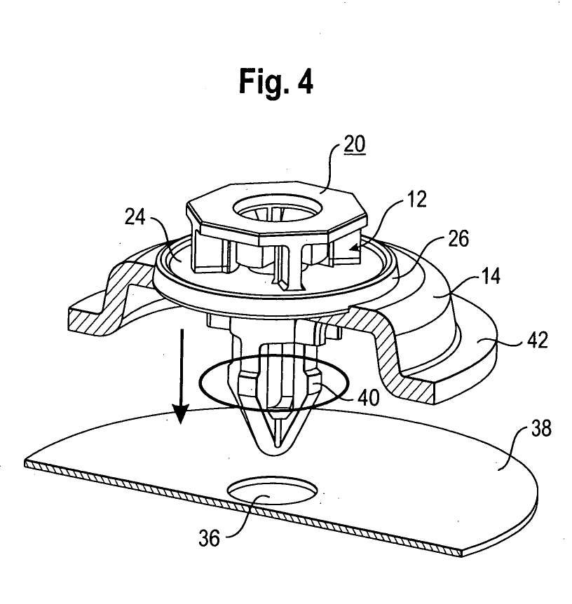

As illustrated in FIG. 4, the fastening clip 12 is inserted into the bore 36 of a door plate 38 as a pre-assembled unit with the module support part 14. The module support 14 is held with the fastening clip 12 in the bore 36 of the door plate 38 via detent elements 40 on the shaft 18. The module support 14 has a flange 42 by which it lies tightly against the door plate 38 in the assembled state.

The fastening element 30 of the panelling part comprises a pin-shaped section 44 by which it engages into the mounting 28 in the head part 20 of the fastening clip 12. A centering of the fastening element 30 takes place via a chamfer 46 in the mounting 28.

The pin-shaped section 44 of the fastening element has in addition a detent ring 48 by which the pin-shaped section 44 is secured in the mounting 28 in the head part. The detent ring can additionally be provided with a sealing lip 50 which seals the pin-shaped section 44 against the mounting 28 in the head part 12. Furthermore, the pin-shaped section 44 has a sealing ring 52 in the form of an O-ring which, in the mounted state, seals the pin-shaped section 44 to the opening 16 in the module support.

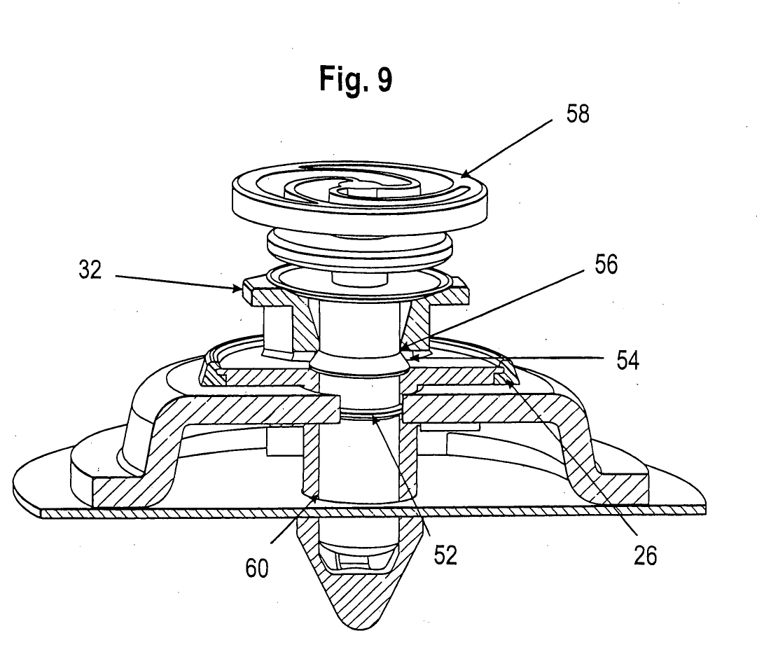

Finally, the fastening element 30 can have a head part with tolerance-equalizing means designated with reference numeral 58 for equalizing of tolerances in the doghouse of the door panelling, as shown in FIG. 9.

Referring to FIG. 9, reference numeral 32 designates the drive section of the head part 20. The drive section is formed as an octagon and serves for mounting the fastening clip into the module support. A stop in the fastening clip is designated with reference numeral 54.

The detention of the pin-shaped section of the fastening element to the fastening clip 12 is shown by reference numeral 56. The expected extraction force of the fastening element is about 130 N.

Reference numeral 52 denotes the seal at the fastening element 30 which seals the fastening element 30 to the fastening clip 12 in the mounted state.

Referring to FIG. 9 again, the fastening clip 12 has a circumferential seal 26 which seals the fastening clip 12 against the module support part 14 in the mounted state.

Reference numeral 60 denotes the securing of the detent elements 40 by the fastening element 30 in the final mounting position. The expected extraction force of the fastening clip 12 from the door plate is greater than about 250 N. The extraction force of the fastening element 30 from the fastening clip 12 should be lower that the extraction force of the fastening clip 12 from the door plate.

1. A fastening device, in particular for fastening a module support and a panelling piece on a raw component of a motor vehicle, comprising
a fastening clip and a module support part, wherein the module support part has an opening to receive the fastening clip, wherein the fastening clip has a shaft and a head part which is formed onto the shaft and wherein locking elements are provided on the shaft underneath the head part, wherein the locking elements engage into the opening of the module support part and secure the fastening clip on the module support part.

2. The fastening device according to claim 1, wherein the shaft has one or more detent elements for mounting in the bore of the raw component.

3. The fastening device according to claim 1, wherein the locking elements are formed by one or more projections protruding radially from the shaft.

4. The fastening device according to claim 1, wherein the head part has a disc-shaped element with a circumferential seal for sealing the opening in the head part.

5. The fastening device according to claim 1, wherein the head part has a mounting for a fastening element of the panelling part.

6. The fastening device according to claim 1, wherein the head part has a drive section with an outer edge.

7. The fastening device according to claim 1, wherein the module support part has a stop for the locking elements.

8. The fastening device according to claim 1, wherein the module support part has a flange for tight abutment against the raw component.

9. The fastening device according to claim 1, wherein the opening in the module support part corresponds to the shape of the locking elements.

10. The fastening device according to claim 1, wherein the fastening clip and the module support part form a pre-assembled unit.

11. The fastening device according to claim 5, wherein the fastening element for the panelling part has a pin-shaped section which engages into the mounting of the head part.

12. The fastening device according to claim 11, wherein the shaft has a cavity corresponding to the mounting in the head part and the pin-shaped section of the fastening element engages into the cavity.

13. The fastening device according to claim 11, wherein the pin-shaped section has a detent ring by which the pin-shaped section is secured in the mounting of the head part.

14. The fastening device according to claim 11, wherein the pin-shaped section has a seal which seals the pin-shaped section to the opening in the module support.

15. The fastening device according to claim 13, wherein the detent ring has a sealing lip which seals the pin-shaped section against the mounting of the head part.

16. The fastening device according to claim 5, wherein the fastening clip and the module support part are formed from plastic.

17. The fastening device according to claim 1, wherein the fastening element of the panelling part has a head part comprising tolerance equalizing means.
